(19) United States
(12) Patent Application Publication
(10) Pub. No.: US 2023/0202518 A1
(43) Pub. Date: Jun. 29, 2023

(54) METHOD FOR PLANNING ROUTE, ELECTRONIC DEVICE AND STORAGE MEDIUM

(71) Applicant: Apollo Intelligent Driving Technology (Beijing) Co., Ltd., Beijing (CN)

(72) Inventor: Kuan Zhang, Beijing (CN)

(21) Appl. No.: 18/112,766

(22) Filed: Feb. 22, 2023

(30) Foreign Application Priority Data
Mar. 7, 2022 (CN) 202210216743.7

(51) Int. Cl. B60W 60/00; B60W 30/18

(52) U.S. Cl. CPC B60W 60/0011; B60W 30/18154; B60W 30/18163; B60W 60/0015; B60W 2520/06

(57) ABSTRACT

A method and apparatus for planning a route, and a readable storage medium are provided. An implementation of the method includes: in a process of that an autonomous vehicle travels according to a first travelling route, in response to a situation where changing from a current lane to a target lane at a vehicle lane-changing permitted road section is planned for the autonomous vehicle but the autonomous vehicle is unable to change to the target lane, determining for the autonomous vehicle a permitted travel direction at a target intersection, the target intersection being a road intersection in front of the autonomous vehicle and corresponding to the vehicle lane-changing permitted road section, and the first travelling route being a travelling route pre-planned for a target starting point and a target ending point; and planning, based on the permitted travel direction, a second travelling route for the autonomous vehicle to pass through the target intersection to reach the target ending point.

### CROSS-REFERENCE TO RELATED APPLICATIONS

This application claims priority to Chinese Patent Application No. 202210216743.7, filed with the China National Intellectual Property Administration (CNIPA) on Mar. 7, 2022, the content of which is incorporated herein by reference in its entirety.

### TECHNICAL FIELD

The present disclosure relates to the field of artificial intelligence, in particular to autonomous driving and intelligent transportation technologies, and may be used in smart city and intelligent transportation scenarios.

### BACKGROUND

When an autonomous vehicle travels from a starting point to an ending point, it usually first plans a travelling route from the starting point to the ending point, and then travels according to the planned travelling route.

During travelling according to the planned travelling route, the autonomous vehicle often encounters a situation where it needs to change lanes but is unable to change to a target lane from a current lane. In addition, if this situation cannot be handled properly, it usually brings safety hazards to road traffic.

### SUMMARY

Embodiments of the present disclosure provides a method for planning a route, an electronic device, and a readable storage medium.

According to a first aspect, some embodiments of the present disclosure provide a method for planning a route. The method includes: in a process of that an autonomous vehicle travels according to a first travelling route, in response to a situation where changing from a current lane to a target lane at a vehicle lane-changing permitted road section is planned for the autonomous vehicle but the autonomous vehicle is unable to change to the target lane, determining for the autonomous vehicle a permitted travel direction at a target intersection, the target intersection being a road intersection in front of the autonomous vehicle and corresponding to the vehicle lane-changing permitted road section, and the first travelling route being a travelling route pre-planned for a target starting point and a target ending point; and planning, based on the permitted travel direction, a second travelling route for the autonomous vehicle to pass through the target intersection to reach the target ending point.

According to a second aspect of the present disclosure, some embodiments of the present disclosure provide an electronic device. The electronic device includes: at least one processor; and a memory communicatively connected to the at least one processor; where the memory stores instructions that, when executed by the at least one processor, cause the at least one processor to perform the method according to any one of the implementations described in the first aspect.

According to a third aspect, some embodiments of the present disclosure provide a non-transitory computer readable storage medium storing computer instructions that, when executed by a computer, cause the computer to perform the method according to any one of the implementations described in the first aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure. In which:

FIG. 1 is a flowchart of a method for planning a route provided in an embodiment of the present disclosure;

FIG. 2 is a schematic diagram of a vehicle travelling provided in an embodiment of the present disclosure;

FIG. 3 is a flowchart of a method for determining a permitted direction of traffic provided in an embodiment of the present disclosure;

FIG. 4 is a schematic diagram of another vehicle travelling provided in an embodiment of the present disclosure;

FIG. 5 is a schematic diagram of a third vehicle travelling provided in an embodiment of the present disclosure;

FIG. 6 is a flowchart of a method for judging a lane merging situation provided in an embodiment of the present disclosure;

FIG. 7 is a flowchart of a method for determining a target lane provided in an embodiment of the present disclosure;

FIG. 8 is a flowchart of another method for planning a route provided in an embodiment of the present disclosure;

FIG. 9 is a schematic diagram of an apparatus for planning a route provided in an embodiment of the present disclosure; and

FIG. 10 is a schematic diagram of an electronic device according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope of the present disclosure. Similarly, for clearness and conciseness, descriptions of well-known functions and structures are omitted in the following description.

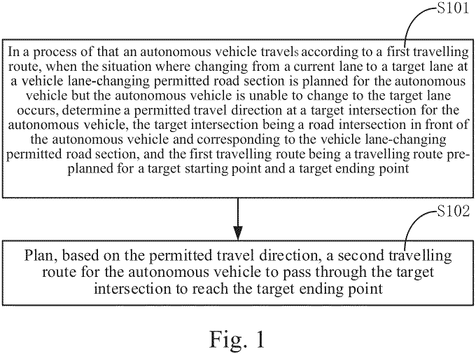

An embodiment of the present disclosure provides a method for planning a route. For details, reference may be made to FIG. 1, which is a flowchart of a method for planning a route. The method shown in FIG. 1 may include the following steps:

Step S101: in a process of an autonomous vehicle traveling according to a first travelling route, in response to a situation where changing from a current lane to a target lane at a vehicle lane-changing permitted road section is planned for the autonomous vehicle but the autonomous vehicle is unable to change to the target lane, determining a permitted travel direction at a target intersection for the autonomous vehicle, the target intersection being a road intersection in front of the autonomous vehicle and corresponding to the vehicle lane-changing permitted road section, and the first travelling route being a travelling route pre-planned for a target starting point and a target ending point.

Step S102: planning, based on the permitted travel direction, a second travelling route for the autonomous vehicle to pass through the target intersection to reach the target ending point.

The method for planning a route provided in embodiments of the present disclosure, in the process of that the autonomous vehicle travels according to the first travelling route, when the situation where the autonomous vehicle needs to perform lane-changing to switch to the target lane from the current lane at the vehicle lane-changing permitted road section but the autonomous vehicle is unable to change to the target lane occurs, first, the permitted travel direction at the target intersection may be determined for the autonomous vehicle. Then, the second travelling route for the autonomous vehicle to pass through the target intersection to reach the target ending point is re-planned based on the permitted travel direction. Therefore, in the case of that the vehicle needs to change to the target lane from the current lane at a vehicle lane-changing permitted road section but is unable to change to the target lane, it can be avoided that the autonomous vehicle keeps waiting on the current lane for an opportunity to change to the target lane in order to follow the first travelling route. Thus, any traffic safety problems caused by the autonomous vehicle keeping waiting on the current lane for the opportunity to change to the target lane can be avoided. Therefore, road traffic safety can be improved.

When the situation where the autonomous vehicle is planned to perform lane-changing at a vehicle lane-changing permitted road section to change to the target lane from the current lane but the autonomous vehicle is unable to change to the target lane occurs, if the autonomous vehicle continues travelling according to the first travelling route, the autonomous vehicle needs to keep waiting on the current lane until there is an opportunity to change to the target lane from the current lane before continuing to travel to change to the target lane. If the autonomous vehicle keeps waiting on the current lane for the opportunity to change to the target lane from the current lane, it may cause road traffic safety hazards. For example, the autonomous vehicle violates an instruction from a road traffic light while waiting, the autonomous vehicle causes traffic jams or collides with a vehicle behind while waiting.

However, if the autonomous vehicle continues to travel according to the re-planned second travelling route, it can be avoided that the autonomous vehicle keeps waiting on the current lane for the opportunity to change to the target lane in order to follow the first travelling route. Thus, the occurrence of the above road traffic safety hazards can be avoided. Therefore, road traffic safety can be improved.

In embodiments of the present disclosure, the vehicle lane-changing permitted road section includes a road section on the current road on which the autonomous vehicle is travelling, where motor vehicles are permitted to perform lane-changing at the road section. For example: a road section, whose lane line is a dashed line, on the current road on which the autonomous vehicle is travelling.

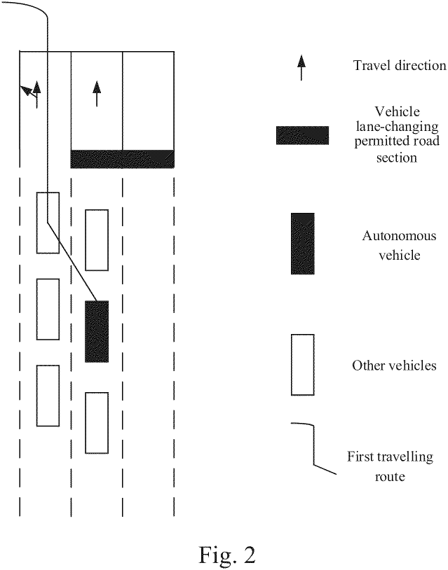

The scenario in which the autonomous vehicle needs to change to the target lane from the current lane at the vehicle lane-changing permitted road section include: in order to pass through the target intersection according to the first travelling route, the autonomous vehicle needs to change to the target lane from the current lane before passing through the target intersection. Referring to FIG. 2, which is a schematic diagram of a vehicle travelling provided in an embodiment of the present disclosure. It can be seen from the first travelling route as shown in FIG. 2, that the autonomous vehicle needs to turn left to pass through the target intersection during travelling according to the first travelling route, while the current lane on which the autonomous vehicle is travelling currently is a straight lane. Then, in order to pass through the target intersection according to the first travelling route, the autonomous vehicle needs to perform lane-changing at the vehicle lane-changing permitted road section to change to the left-turn lane from the straight lane. In this scenario, the current lane is: straight lane, and the target lane is: left-turn lane.

In addition, during that the autonomous vehicle is travelling according to the first travelling route, if the autonomous vehicle needs to go straight to pass through the target intersection, while the current lane on which the autonomous vehicle is travelling currently is the left-turn lane, then, in order to pass through the target intersection according to the first travelling route, the autonomous vehicle needs to change to the straight lane from the left-turn lane at the vehicle lane-changing permitted road section. In this scenario, the current lane is: left-turn lane, and the target lane is: straight lane.

It should be noted that, the first travelling route requires that the autonomous vehicle must have changed from the current lane to the target lane after the vehicle lane-changing permitted road section. The first travelling route shown in FIG. 2 is only an example of a first travelling route.

In embodiments of the present disclosure, there is no specific limitation to the scenario in which the autonomous vehicle needs to change to the target lane from the current lane in the vehicle lane-changing permitted road section.

The intersection in front of the autonomous vehicle and corresponding to the vehicle lane-changing permitted road section includes: an intersection which is ahead of a current travelling direction of the autonomous vehicle, and adjacent to or connected to the vehicle lane-changing permitted road section. In some embodiments, the intersection in front of the autonomous vehicle and corresponding to the vehicle lane-changing permitted road section may be an intersection in front of the current travelling direction of the autonomous vehicle and closest to the vehicle lane-changing permitted road section.

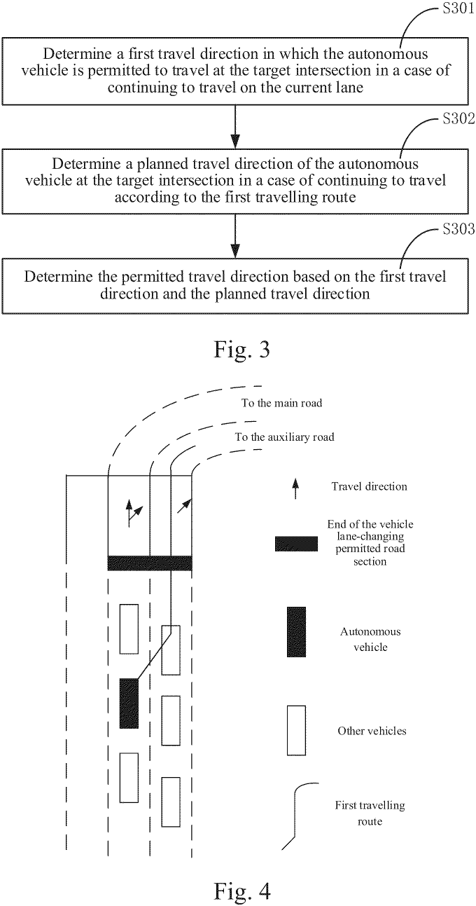

In an embodiment of the present disclosure, the step of determining a permitted travel direction of the autonomous vehicle at a target intersection may be as shown in FIG. 3. FIG. 3 is a flowchart of a method for determining a permitted travel direction provided in an embodiment of the present disclosure. The method as shown in FIG. 3 includes the following steps:

Step S301: determining a first travel direction in which the autonomous vehicle is permitted to travel at the target intersection in the case of that the autonomous vehicle continues travelling on the current lane.

Step S302: determining a planned travel direction of the autonomous vehicle at the target intersection in the case of that the autonomous vehicle continues travelling according to the first travelling route.

Step S303: determining the permitted travel direction using the first travel direction and the planned travel direction.

In this embodiment of the present disclosure, since the autonomous vehicle is currently travelling on the current lane, thus, in order to prevent the autonomous vehicle from being waiting on the current lane due to being unable to change lanes, the first travel direction(s) needs to be given priority when determining the permitted travel direction(s). In addition, the second travelling route is planned for the autonomous vehicle to pass through the target intersection, in order to avoid a high probability of planning failure of the second travelling route due to that the planned travel direction is still taken into account, the planned travel direction also needs to be took into account when determining the permitted travel direction.

A detailed implementation process of determining the permitted travel direction using the first travel direction and the planned travel direction may be as follows: first, obtaining all travel directions at the intersection corresponding to a target exit, where the target exit is an exit to the target intersection, then, excluding the planned travel direction from all the travel directions at the intersection to obtain candidate travel direction(s), and finally, determining the permitted travel direction(s) based on a direction intersection between the candidate travel direction(s) and the first travel direction(s).

In practical applications, the following formula may be used to determine the permitted travel direction(s) using the first travel direction(s) and the planned travel direction:

$$A = \left(B - C\right) ∩ D$$

In the above formula, A may be used to represent the permitted travel direction(s); B may be used to represent all the travel directions at the intersection; C may be used to represent the planned travel direction; and D may be used to represent the first travel direction(s).

Determining the permitted travel direction(s) using the above formula can avoid the planned travel direction being included in the permitted travel direction(s).

Because in practical applications, both the first travel direction(s) and the planned travel direction are directions. Therefore, at some road intersections, it often occurs that although the travel directions corresponding to different lanes are the same at a traffic level, destinations that a vehicle can reach by travelling in this same direction but on different lanes are different. For example: the vehicle traveling on a first lane on the right side turns right at the target intersection and then goes to the auxiliary road, while the vehicle traveling on a second lane on the right side turns right at the target intersection and then goes to the main road, the destinations that a vehicle can reach by travelling on different lanes but in the same direction are different.

In the process of that the autonomous vehicle travels according to the first travelling route, when the situation where the vehicle needs to change to the target lane from the current lane at the vehicle lane-changing permitted road section but the vehicle is unable to change to the target lane occurs, and the first travel direction(s) includes a travel direction same as the planned travel direction (that is, the first travel direction(s) includes the planned travel direction), if the planned travel direction had been also determined as a permitted travel direction, there is often a problem that the vehicle passes through the target intersection according to the planned travel direction and the current lane, the corresponding route cannot reach the target ending point, thus causing planning failure of this second route planning.

Therefore, preventing the planned travel direction from being included in the permitted travel direction can improve the success rate of planning of the second travelling route.

In an embodiment of the present disclosure, the situation, in which although the travel directions corresponding to different lanes at the target intersection are the same at the direction level, destinations that vehicles can reach by travelling on different lanes but in this same direction are different, details may refer to FIG. 4. FIG. 4 is a schematic diagram of another vehicle travelling provided in an embodiment of the present disclosure. The first travelling route requires that the vehicle has changed to the target route from the current lane after the vehicle lane-changing permitted road section. The first travelling route shown in FIG. 4 is only an example of the first travelling route.

In FIG. 4, the current lane is the second lane on the right side on the current travelling road, and the first travel directions corresponding to the second lane on the right side at the target intersection include: “turn right”, and “go straight”. A vehicle traveling on the second lane on the right may turn right at the target intersection and then goes to main road. In addition, the target lane in FIG. 4 is the first lane on the right side of the current travelling road, and the first travel direction corresponding to the first lane on the right side at the target intersection is: “turn right”. A vehicle traveling on the first lane on the right may turn right at the target intersection and then goes to the auxiliary road corresponding to the main road.

If the autonomous vehicle cannot reach the target ending point by travelling on the main road, it corresponds to the case: the first travel directions (“go straight”, “turn right”) include the planned travel direction (“turn right”), but if the autonomous vehicle continues travelling according to the planned travel direction (“turn right”) on the current lane (the second lane on the right), it cannot reach the target ending point. In this case, the planned travel direction being included in the permitted traffic direction(s) is avoided by determining the permitted travel direction(s) using the above method, thereby improving the success rate of planning of the second travelling route.

In an embodiment of the present disclosure, the detailed implementation of determining the permitted travel direction(s) of the autonomous vehicle at the target intersection may also be: first, obtaining all travel directions at the intersection corresponding to a target exit, where the target exit is an exit to the target intersection. Secondly, excluding the planned travel direction from the all travel directions at the intersection. Thirdly, determining a second travel direction in which the autonomous vehicle is permitted to travel at the target intersection in a case of that the autonomous vehicle travels on another lane, where the another lane includes a lane to which the autonomous vehicle can change from the current lane at the vehicle lane-changing permitted road section. Fourthly, obtaining a direction union between the first travel direction(s) and the second travel direction(s). Fifthly, determining the permitted travel direction based on a direction intersection between the candidate travel direction(s) and the direction union,

Obtaining the permitted travel direction(s) using the above method can expand a range of the permitted travel direction(s), and at the same time ensure that the planned traffic direction is not included in the permitted travel direction(s). Therefore, meanwhile the selectivity of planning the second travelling route is improved, the success rate of planning of the second travelling route is also guaranteed.

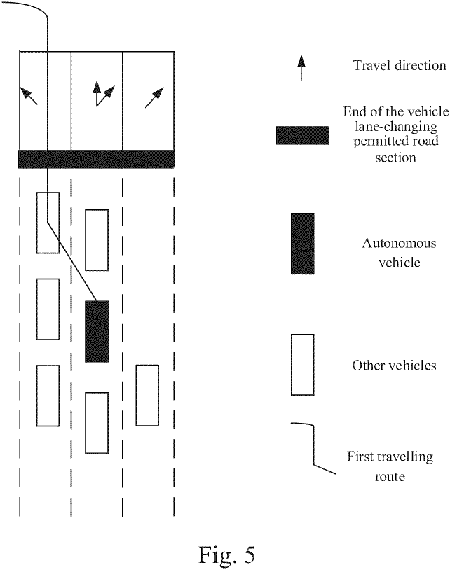

The situation may be as shown in FIG. 5. FIG. 5 is a schematic diagram of a third vehicle travelling provided in an embodiment of the present disclosure. The autonomous vehicle is travelling on the middle lane (the current lane) of three lanes on the left side of the road, if the autonomous vehicle needs to change to the target lane (first lane on the left) from the current lane but is not able change to the target lane at the vehicle lane-changing permitted road section, but the autonomous is able to change to another lane (third lane on the left) at the vehicle lane-changing permitted road section, the permitted travel direction may be obtained using the following manners:

First, obtaining all travel directions (“go straight”, “turn right”, “turn left”) at the intersection, and excluding the planned travel direction (that is, the travel direction at the target intersection after changing to the first lane on the left: “turn left”) from the all travel directions at the intersection to obtain the candidate travel directions (“go straight”, “turn right”). Then, obtaining the first travel directions (travel directions at the target intersection when continuing travelling on the current lane: “go straight”, “turn right”) and the second travel direction (travel direction at the target intersection after changing to the third lane on the left: “turn right”), and obtaining the direction union (“go straight”, “turn right”) between the first travel directions and the second travel direction. Finally, obtaining the direction intersection (“go straight”, “turn right”) between the candidate travel directions and the direction union, and determining the directions in the direction intersection as the permitted travel directions (“go straight”, “turn right”).

It should be noted that, the middle lane in FIG. 5 is the current lane, and the travel directions corresponding to the middle lane at the target intersection include: “go straight”, “turn right”; the third lane on the left is the lane on the right side of the middle lane, and the first travel direction corresponding to the third lane on the left at the target intersection includes: “turn right”; the first lane on the left is the lane on the left side of the middle lane, and the travel direction corresponding to the first lane on the left at the target intersection includes: “turn left”.

In addition, the first travelling route requires that the vehicle has changed to the target lane from the current lane after the vehicle lane-changing permitted road section. The first travelling rote shown in FIG. 5 is only an example of the first travelling route.

In practical applications, the following formula may be used to determine the permitted travel direction(s) using the first travel direction(s) and the planned travel direction:

$$A = \left(B - C\right) ∩ ∩ \left(D ∪ Ε\right)$$

In the above formula, A may be used to represent the permitted travel direction(s); C may be used to represent the planned travel direction; D may be used to represent the first travel direction(s); and E may be used to represent the second travel direction(s).

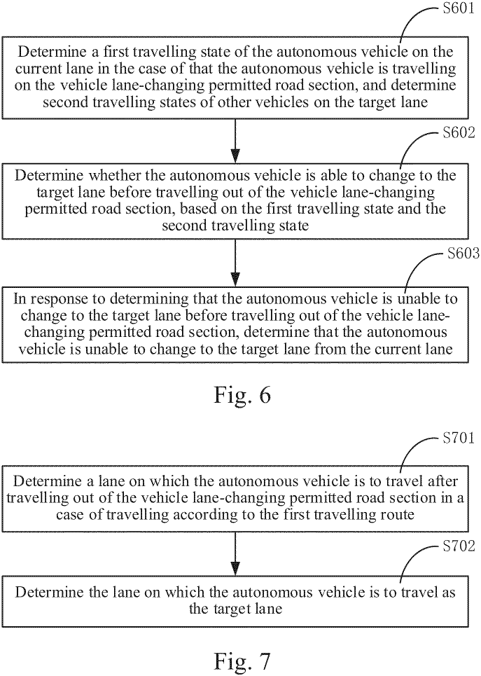

In an embodiment of the present disclosure, the detailed implementation for determining that the autonomous vehicle is unable to change to the target lane from the current lane is as shown in FIG. 6, FIG. 6 is a flowchart of a method for judging a lane changing situation provided in an embodiment of the present disclosure. The method as shown in FIG. 6 includes the following steps:

Step S601: determining a first travelling state of the autonomous vehicle on the current lane in the case of that the autonomous vehicle is travelling at the vehicle lane-changing permitted road section, and determining second travelling state(s) of other vehicle(s) on the target lane.

Step S602: determining whether the autonomous vehicle is able to change to the target lane before travelling out of the vehicle lane-changing permitted road section, based on the first travelling state and the second travelling state.

Step S603: in response to determining that the autonomous vehicle is unable to change to the target lane before travelling out of the vehicle lane-changing permitted road section, determining that the autonomous vehicle is unable to change to the target lane from the current lane.

In the case that the autonomous vehicle is unable to change to the target lane before travelling out of the vehicle lane-changing permitted road section, it may be determined that the autonomous vehicle is not able to change to the target lane from the current lane.

In embodiments of the present disclosure, the first travelling state includes, but not limited to: a real-time position and a posture of the autonomous vehicle, a real-time travelling speed of the autonomous vehicle, and a distance required for the autonomous vehicle to travel out of the vehicle lane-changing permitted road section. The second travelling state includes, but not limited to: the number of other vehicles, distances between the other vehicles, real-time travelling speeds of the other vehicles, real-time positions and postures of the other vehicles, and distances required for the other vehicles to travel out of the vehicle lane-changing permitted road section.

Before the autonomous vehicle travels out of the vehicle lane-changing permitted road section may include: before the autonomous vehicle arrives an ending point of the vehicle lane-changing permitted road section.

The other vehicles include but not limited to unmanned vehicles and manned vehicles. In general, social vehicles travelling on the target lane synchronously with the autonomous vehicle are all other vehicles.

In an embodiment of the present disclosure, a method for determining the target lane is as shown in FIG. 7, FIG. 7 is a flowchart of a method for determining a target lane. The method as shown in FIG. 7 includes the following steps:

Step S701: determining a lane on which the autonomous vehicle is to travel after travelling out of the vehicle lane-changing permitted road section in the case of travelling according to the first travelling route.

Step S702: determining the lane on which the autonomous vehicle is to travel as the target lane.

Since the autonomous vehicle may perform lane change before travelling out of the vehicle lane-changing permitted road section, in order to enable the autonomous vehicle to pass through the target intersection according to the first travelling route, the autonomous vehicle is required to travel on the target lane after travelling out of the vehicle lane-changing permitted road section. Therefore, in the case of travelling according to the first travelling route, the lane on which the autonomous vehicle is required to travel after travelling out of the vehicle lane-changing permitted road section may be determined as the target lane, so that the target lane can be accurately and simply determined.

In an embodiment of the present disclosure, a method for planning the second travelling route is: first, determining a current location of the autonomous vehicle as a new starting point. Then, planning the second travelling route for the new starting point and the target ending point.

Determining the current location of the autonomous vehicle as the new starting point to plan the second travelling route for the autonomous vehicle to pass through the target intersection to reach the target ending point can make the second travelling route have better adaptability to road traffic conditions. In the process of planning the first travelling route, a real-time traffic condition on the road is generally considered when the first travelling route is planned. While in the process of the autonomous vehicle travelling from the target starting point to the new starting point, the real-time traffic condition on the road usually changes. Therefore, the new starting point is re-determined, and the second travelling route is planned for the new starting point and the target ending point, thereby improving the adaptability of the second travelling route to road traffic conditions.

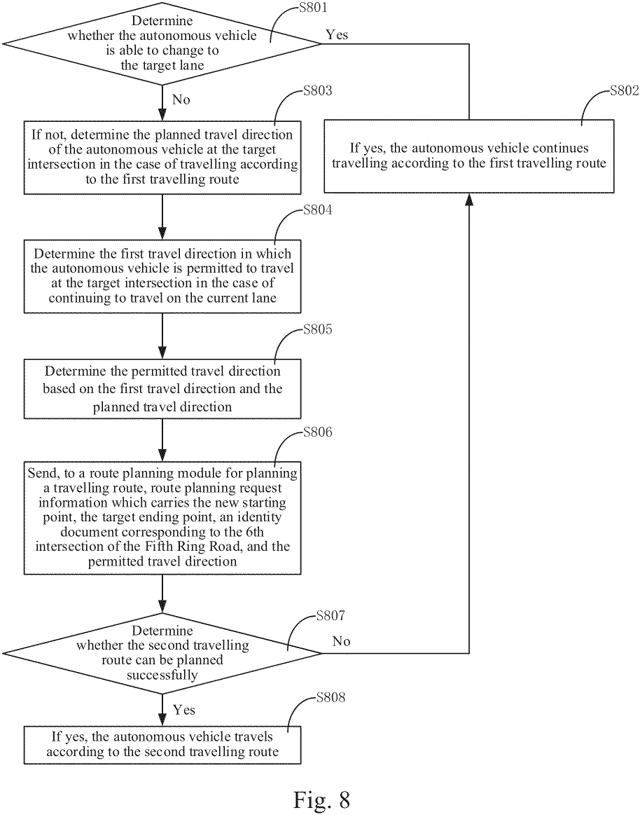

An example of the method for planning a route provided in an embodiment of the present disclosure will be described below. Referring to FIG. 8, FIG. 8 is a flowchart of another method for planning a route provided in an embodiment of the present disclosure. The method as shown in FIG. 8 includes the following steps:

Step S801: determining whether the autonomous vehicle is able to change to the target lane. In the process of that the autonomous vehicle travels according to the first travelling route, as long as the vehicle needs to change to the target lane from the current lane at a vehicle lane-changing permitted road section, whether the autonomous vehicle is able to change to the target lane from the current lane is determined.

For example: in the process of travelling according to the first travelling route, if the vehicle is travelling at a vehicle lane-changing permitted road section before the 6th intersection of the Fifth Ring Road and needs to change lanes, then whether the autonomous vehicle is able to change to the target lane from the current lane is determined.

Step S802: if yes, the autonomous vehicle continues travelling according to the first travelling route.

Step S803: if not, determining the planned travel direction of the autonomous vehicle at the target intersection in the case of that the autonomous vehicle continues travelling according to the first travelling route. In the case of travelling according to the first travelling route, the travel direction of the autonomous vehicle at the 6th intersection of the Fifth Ring Road is “‘turn left”, then the planned travel direction is “turn left”.

Step S804: determining the first travel direction in which the autonomous vehicle is permitted to travel at the target intersection in the case of that the autonomous vehicle continues travelling on the current lane. In the case of continuing travelling according to the current lane, the directions in which the autonomous vehicle is permitted to travel at the 6th intersection of the Fifth Ring Road is “turn left” and “go straight”, then the first travel direction is “turn left” and “go straight”.

Step S805: determining the permitted travel direction using the first travel direction and the planned travel direction. A=(B-C)∩D may be used to calculate the permitted travel direction. In this regard, C includes “turn left”, and D includes “turn left” and “go straight”. If D is “turn left”, “go straight”, “turn right”, and “U-turn”, then A is (“go straight”, “turn right”, and “U-turn”) ∩ (“go straight”, “turn left”). That is, the permitted travel direction of A is “go straight”.

Step S806: sending, to a route planning module for planning travelling route, route planning request information carrying the new starting point, the target ending point, an identity document (ID) corresponding to the 6th intersection of the Fifth Ring Road, and the permitted travel direction. The route planning module parses the route planning request information and obtains the new starting point, the target ending point, the ID corresponding to the 6th intersection of the Fifth Ring Road to plan a second route. The route planning module is a pre-configured module for planning travelling route.

Step S807: determining whether the second travelling route can be planned successfully.

Step S808: if yes, the autonomous vehicle travels according to the second travelling route.

In addition, if the planning of the second travelling route is unsuccessful, the autonomous vehicle continues travelling according to the first travelling route. That is, if the planning of the second travelling route is unsuccessful, step S802 is indicated.

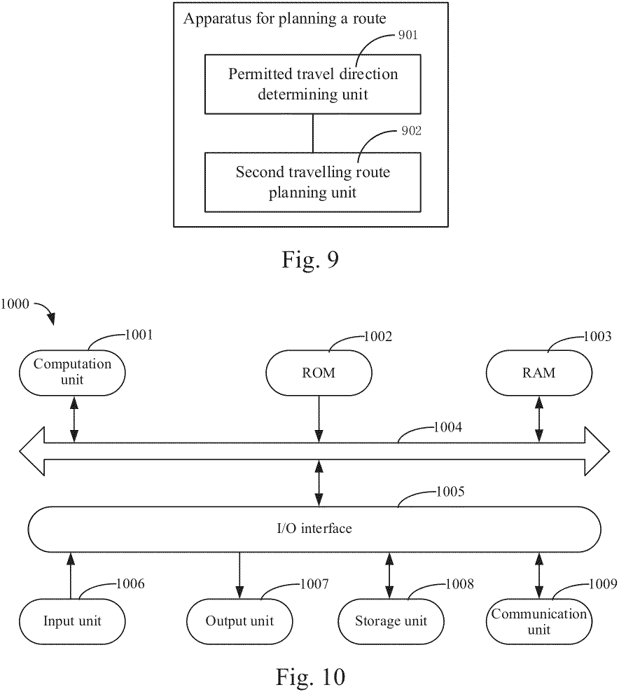

As shown in FIG. 9, an apparatus for planning a route is provided in an embodiment of the present disclosure, and the apparatus includes:
a permitted travel direction determining unit 901, configured to, in a process of that an autonomous vehicle travels according to a first travelling route, in response to a situation where changing from a current lane to a target lane at a vehicle lane-changing permitted road section is planned for the autonomous vehicle but the autonomous vehicle is unable to change to the target lane, determine for the autonomous vehicle a permitted travel direction at a target intersection, the target intersection being a road intersection in front of the autonomous vehicle and corresponding to the vehicle lane-changing permitted road section, and the first travelling route being a travelling route pre-planned for a target starting point and a target ending point; and
a second travelling route planning unit 902, configured to plan, based on the permitted travel direction, a second travelling route for the autonomous vehicle to pass through the target intersection to reach the target ending point.

In an embodiment, the permitted travel direction determining unit 901 may include:
a first travel direction determining subunit, configured to, determine a first travel direction in which the autonomous vehicle is permitted to travel at the target intersection in a case of continuing travelling on the current lane;
a planned travel direction determining subunit, configured to, determine a planned travel direction of the autonomous vehicle at the target intersection in a case of continuing travelling according to the first travelling route; and
a first permitted travel direction determining subunit, configured to determine the permitted travel direction based on the first travel direction and the planned travel direction.

In an embodiment, the first permitted travel direction determining subunit may include:
an intersection travel direction determining subunit, configured to obtain all travel directions at the intersection corresponding to a target exit, wherein the target exit is an exit of the target intersection;
a candidate travel direction determining subunit, configured to exclude the planned travel direction from the all travel directions at the intersection, to obtain a candidate travel direction; and
a second permitted travel direction determining subunit, configured to determine the permitted travel direction based on a direction intersection between the candidate travel direction and the first travel direction.

In an embodiment, the first permitted travel direction determining subunit may include:
an intersection travel direction determining subunit, configured to obtain all travel directions at the intersection corresponding to a target exit, wherein the target exit is an exit of the target intersection;
a candidate travel direction determining subunit, configured to exclude the planned travel direction from the all travel directions at the intersection, to obtain a candidate travel direction;
a second travel direction determining subunit, configured to, in a case of travelling in another lane, determine a second travel direction in which the autonomous vehicle is permitted to travel at the target intersection in a case of travelling in another lane, wherein the another lane comprises a lane to which the autonomous vehicle is able to change from the current lane at the vehicle lane-changing permitted road section;
a direction union obtaining subunit, configured to obtain a direction union between the first travel direction and the second travel direction; and
a third permitted travel direction determining subunit, configured to determine the permitted travel direction based on a direction intersection between the candidate travel direction and the direction union.

In an embodiment, the permitted travel direction determining unit 901 may include:
a travelling state determining subunit, configured to, determine a first travelling state of the autonomous vehicle on the current lane in a case of travelling on the vehicle lane-changing permitted road section, and determine second travelling states of other vehicles on the target lane;
a lane changing judging subunit, configured to determine whether the autonomous vehicle is able to change to the target lane before travelling out of the vehicle lane-changing permitted road section, based on the first travelling state and the second travelling state; and
a lane merging determining subunit, configured to, in response to determining that the autonomous vehicle is unable to change to the target lane before travelling out of the vehicle lane-changing permitted road section, determine that the autonomous vehicle is unable to perform lane-changing to change from the current lane to the target lane.

In an embodiment, the permitted travel direction determining unit 901 may include:
a should travelling lane determining subunit, configured to, determine a lane on which the autonomous vehicle is to travel after travelling out of the vehicle lane-changing permitted road section in a case of travelling according to the first travelling route; and
a target lane determining subunit, configured to determine the lane on which the autonomous vehicle is to travel as the target lane.

In an embodiment, the second travelling route planning unit 902 may include:
anew starting point determining subunit, configured to determine a current location of the autonomous vehicle as a new starting point; and
a second travelling route planning subunit, configured to plan the second travelling route based on the new starting point and the target ending point.

In the technical solution of the present disclosure, the acquisition, storage and application of the user personal information involved are in compliance with relevant laws and regulations, and do not violate public order and good customs.

According to an embodiment of the present disclosure, an electronic device and a readable storage medium are provided.

FIG. 10 illustrates a schematic block diagram of an example electronic device 1000 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 10, the device 1000 includes a computation unit 1001, which may perform various appropriate actions and processing, based on a computer program stored in a read-only memory (ROM) 1002 or a computer program loaded from a storage unit 1008 into a random access memory (RAM) 1003. In the RAM 1003, various programs and data required for the operation of the device 1000 may also be stored. The computation unit 1001, the ROM 1002, and the RAM 1003 are connected to each other through a bus 1004. An input/output (I/O) interface 1005 is also connected to the bus 1004.

A plurality of parts in the device 1000 are connected to the I/O interface 1005, including: an input unit 1006, for example, a keyboard and a mouse; an output unit 1007, for example, various types of displays and speakers; the storage unit 1008, for example, a disk and an optical disk; and a communication unit 1009, for example, a network card, a modem, or a wireless communication transceiver. The communication unit 1009 allows the device 1000 to exchange information/data with other devices over a computer network such as the Internet and/or various telecommunication networks.

The computation unit 1001 may be various general-purpose and/or dedicated processing components having processing and computing capabilities. Some examples of the computation unit 1001 include, but are not limited to, central processing unit (CPU), graphics processing unit (GPU), various dedicated artificial intelligence (AI) computing chips, various computation units running machine learning model algorithms, digital signal processors (DSP), and any appropriate processors, controllers, microcontrollers, etc. The computation unit 1001 performs the various methods and processes described above, such as a method for planning a route. For example, in some embodiments, the method for planning a route may be implemented as a computer software program, which is tangibly included in a machine readable medium, such as the storage unit 1008. In some embodiments, part or all of the computer program may be loaded and/or installed on the device 1000 via the ROM 1002 and/or the communication unit 1009. When the computer program is loaded into the RAM 1003 and executed by the computation unit 1001, one or more steps of the method for planning a route described above may be performed. Alternatively, in other embodiments, the computation unit 1001 may be configured to perform the method for planning a route by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output device.

Program codes for implementing the method of the present disclosure may be compiled using any combination of one or more programming languages. The program codes may be provided to a processor or controller of a general-purpose computer, a special-purpose computer, or other programmable apparatuses for processing vehicle-road collaboration information, such that the program codes, when executed by the processor or controller, cause the functions/operations specified in the flow charts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g_{.}, visual feedback, auditory feedback, or haptic feedback); and an input may be received from the user in any form (including an acoustic input, a voice input, or a tactile input).

The systems and technologies described herein may be implemented in a computing system (e.g_{.}, as a data server) that includes a back-end component, or a computing system (e.g., an application server) that includes a middleware component, or a computing system (e.g_{.}, a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relatiotiship between the client and the server arises by virtue of computer programs that run on corresponding computers and have a client-server relationship with each other. The server may be a cloud server, a distributed system server, or a server combined with a blockchain.

It should be understood that the various forms of processes shown above may be used to reorder, add, or delete steps. For example, the steps disclosed in embodiments of the present disclosure may be executed in parallel, sequentially, or in different orders, as long as the desired results of the technical solutions disclosed in embodiments of the present disclosure can be implemented. This is not limited herein.

The above implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the principle of the present disclosure should be encompassed within the scope of protection of the present disclosure.

What is claimed is:

1. A method for planning a route, comprising:
in a process of that an autonomous vehicle travels according to a first travelling route, in response to a situation where changing from a current lane to a target lane at a vehicle lane-changing permitted road section is planned for the autonomous vehicle but the autonomous vehicle is unable to change to the target lane, determining for the autonomous vehicle a permitted travel direction at a target intersection, the target intersection being a road intersection in front of the autonomous vehicle and corresponding to the vehicle lane-changing permitted road section, and the first travelling route being a travelling route pre-planned for a target starting point and a target ending point; and
planning, based on the permitted travel direction, a second travelling route for the autonomous vehicle to pass tthrough the target intersection to reach the target ending point.

2. The method according to claim 1, wherein the determining for the autonomous vehicle a permitted travel direction at a target intersection, comprises:
determining a first travel direction in which the autonomous vehicle is permitted to travel at the target intersection in a case of continuing travelling on the current lane;
determining a planned travel direction of the autonomous vehicle at the target intersection in a case of continuing travelling according to the first travelling route; and
determining the permitted travel direction based on the first travel direction and the planned travel direction.

3. The method according to claim 2, wherein the determining the permitted travel direction based on the first travel direction and the planned travel direction, comprises:
obtaining all travel directions at the intersection corresponding to a target exit, wherein the target exit is an exit of the target intersection;
excluding the planned travel direction from the all travel directions at the intersection, to obtain a candidate travel direction, and
determining the permitted travel direction based on a direction intersection between the candidate travel direction and the first travel direction.

4. The method according to claim 2, wherein the determining the permitted travel direction based on the first travel direction and the planned travel direction, comprises:
obtaining all travel directions at the intersection corresponding to a target exit, wherein the target exit is an exit of the target intersection;
excluding the planned travel direction from the all travel directions at the intersection, to obtain a candidate travel direction;
determining a second travel direction in which the autonomous vehicle is permitted to travel at the target intersection in a case of travelling on another lane, wherein the another lane comprises a lane to which the autonomous vehicle is able to change from the current lane at the vehicle lane-changing permitted road section;
obtaining a direction union between the first travel direction and the second travel direction; and
determining the permitted travel direction based on a direction intersection between the candidate travel direction and the direction union.

5. The method according to claim 1, wherein the autonomous vehicle is unable to change to the target lane is determined through:
determining a first travelling state of the autonomous vehicle on the current lane in a case of travelling on the vehicle lane-changing permitted road section, and determining second travelling states of other vehicles on the target lane;
determining whether the autonomous vehicle is able to change to the target lane before travelling out of the vehicle lane-changing permitted road section, based on the first travelling state and the second travelling states; and
in response to determining that the autonomous vehicle is unable to change to the target lane before travelling out of the vehicle lane-changing permitted road section, determining that the autonomous vehicle is unable to perform lane-changing to change from the current lane to the target lane.

6. The method according to claim 1, wherein the target lane is determined through:
determining a lane on which the autonomous vehicle is to travel after travelling out of the vehicle lane-changing permitted road section in a case of travelling according to the first travelling route; and
determining the lane on which the autonomous vehicle is to travel as the target lane.

7. The method according to claim 1, wherein the planning the second travelling route comprises:
determining a current location of the autonomous vehicle as a new starting point; and
planning the second travelling route based on the new starting point and the target ending point.

8. The method according to claim 6, wherein the planning the second travelling route comprises:
determining a current location of the autonomous vehicle as a new starting point;
and planning the second travelling route based on the new starting point and the target ending point.

9. An electronic device, comprising:
at least one processor; and
a memory communicatively connected to the at least one processor; wherein,
the memory stores instructions that, when executed by the at least one processor, cause the at least one processor to perform operations, the operations comprising:
in a process of that an autonomous vehicle travels according to a first travelling route, in response to a situation where changing from a current lane to a target lane at a vehicle lane-changing permitted road section is planned for the autonomous vehicle but the autonomous vehicle is unable to change to the target lane, determining for the autonomous vehicle a permitted travel direction at a target intersection, the target intersection being a road intersection in front of the autonomous vehicle and corresponding to the vehicle lane-changing permitted road section, and the first travelling route being a travelling route pre-planned for a target starting point and a target ending point; and
planning, based on the permitted travel direction, a second travelling route for the autonomous vehicle to pass through the target intersection to reach the target ending point.

10. The electronic device according to claim 9, wherein the determining for the autonomous vehicle a permitted travel direction at a target intersection, comprises:
determining a first travel direction in which the autonomous vehicle is permitted to travel at the target intersection in a case of continuing travelling on the current lane;
determining a planned travel direction of the autonomous vehicle at the target intersection in a case of continuing travelling according to the first travelling route; and
determining the permitted travel direction based on the first travel directi on and the planned travel direction.

11. The electronic device according to claim 10, wherein the determining the permitted travel direction based on the first travel direction and the planned travel direction, comprises:
obtaining all travel directions at the intersection corresponding to a target exit, wherein the target exit is an exit of the target intersection;
excluding the planned travel direction from the all travel directions at the intersection, to obtain a candidate travel direction; and
determining the permitted travel direction based on a direction intersection between the candidate travel direction and the first travel direction.

12. The electronic device according to claim 10, wherein the determining the permitted travel direction based on the first travel direction and the planned travel direction, comprises:
obtaining all travel directions at the intersection corresponding to a target exit, wherein the target exit is an exit of the target intersection;
excluding the planned travel direction from the all travel directions at the intersection, to obtain a candidate travel direction;
determining a second travel direction in which the autonomous vehicle is permitted to travel at the target intersection in a case of travelling on another lane, wherein the another lane comprises a lane to which the autonomous vehicle is able to change from the current lane at the vehicle lane-changing permitted road section;
obtaining a direction union between the first travel direction and the second travel direction; and
determining the permitted travel direction based on a direction intersection between the candidate travel direction and the direction union.

13. The electronic device according to claim 9, wherein the autonomous vehicle is unable to change to the target lane is determined through:
determining a first travelling state of the autonomous vehicle on the current lane in a case of travelling on the vehicle lane-changing permitted road section, and determining second travelling states of other vehicles on the target lane;
determining whether the autonomous vehicle is able to change to the target lane before travelling out of the vehicle lane-changing permitted road section, based on the first travelling state and the second travelling states; and
in response to determining that the autonomous vehicle is unable to change to the target lane before travelling out of the vehicle lane-changing permitted road section, determining that the autonomous vehicle is unable to perform lane-changing to change from the current lane to the target lane.

14. The electronic device according to claim 9, wherein the target lane is determined through:
determining a lane on which the autonomous vehicle is to travel after travelling out of the vehicle lane-changing permitted road section in a case of travelling according to the first travelling route; and
determining the lane on which the autonomous vehicle is to travel as the target lane.

15. The electronic device according to claim 9, wherein the planning the second travelling route comprises:
determining a current location of the autonomous vehicle as a new starting point; and
planning the second travelling route based on the new starting point and the target ending point.

16. A non-transitory computer readable storage medium storing computer instructions that, when executed by a computer, cause the computer to perform operations, the operations comprising:
in a process of that an autonomous vehicle travels according to a first travelling route, in response to a situation where changing from a current lane to a target lane at a vehicle lane-changing permitted road section is planned for the autonomous vehicle but the autonomous vehicle is unable to change to the target lane, determining for the autonomous vehicle a permitted travel direction at a target intersection, the target intersection being a road intersection in front of the autonomous vehicle and corresponding to the vehicle lane-changing permitted road section, and the first travelling route being a travelling route pre-planned for a target starting point and a target ending point; and
planning, based on the permitted travel direction, a second travelling route for the autonomous vehicle to pass through the target intersection to reach the target ending point.

17. The computer readable storage medium according to claim 16, wherein the determining for the autonomous vehicle a permitted travel direction at a target intersection, comprises:
determining a first travel direction in which the autonomous vehicle is permitted to travel at the target intersection in a case of continuing travelling on the current lane;
determining a planned travel direction of the autonomous vehicle at the target intersection in a case of continuing travelling according to the first travelling route; and
determining the permitted travel direction based on the first travel direction and the planned travel direction.

18. The computer readable storage medium according to claim 17, wherein the determining the permitted travel direction based on the first travel direction and the planned travel direction, comprises:
obtaining all travel directions at the intersection corresponding to a target exit, wherein the target exit is an exit of the target intersection;
excluding the planned travel direction from the all travel directions at the intersection, to obtain a candidate travel direction; and
determining the permitted travel direction based on a direction intersection between the candidate travel direction and the first travel direction.

19. The computer readable storage medium according to claim 17, wherein the determining the permitted travel direction based on the first travel direction and the planned travel direction, comprises:
obtaining all travel directions at the intersection corresponding to a target exit, wherein the target exit is an exit of the target intersection;
excluding the planned travel direction from the all travel directions at the intersection, to obtain a candidate travel direction,
determining a second travel direction in which the autonomous vehicle is permitted to travel at the target intersection in a case of travelling on another lane, wherein the another lane comprises a lane to which the autonomous vehicle is able to change from the current lane at the vehicle lane-changing permitted road section;
obtaining a direction union between the first travel direction and the second travel direction; and
determining the permitted travel direction based on a direction intersection between the candidate travel direction and the direction union.

20. The computer readable storage medium according to claim 16, wherein the autonomous vehicle is unable to change to the target lane is determined through:
determining a first travelling state of the autonomous vehicle on the current lane in a case of travelling on the vehicle lane-changing permitted road section, and determining second travelling states of other vehicles on the target lane;
determining whether the autonomous vehicle is able to change to the target lane before travelling out of the vehicle lane-changing permitted road section, based on the first travelling state and the second travelling states; and
in response to determining that the autonomous vehicle is unable to change to the target lane before travelling out of the vehicle lane-changing permitted road section, determining that the autonomous vehicle is unable to perform lane-changing to change from the current lane to the target lane.
